(19) United States
(12) Patent Application Publication
(10) Pub. No.: US 2009/0085768 A1
(43) Pub. Date: Apr. 2, 2009

(54) GLUCOSE SENSOR TRANSCEIVER

(75) Inventors: Himanshu Patel, Northridge, CA (US); Wayne A. Morgan, Northridge, CA (US); Edward Chernoff, Frazier Park, CA (US); John J. Mastrototaro, Los Angeles, CA (US)

Correspondence Address: LEE, HONG, DEGERMAN, KANG & WAIMEY, 660 S. FIGUEROA STREET, Suite 2300, LOS ANGELES, CA, 90017, US

(73) Assignee: MEDTRONIC MINIMED, INC.

(21) Appl. No.: 12/056,651

(22) Filed: Mar. 27, 2008

Related U.S. Application Data
(60) Provisional application No. 60/976,886, filed on Oct. 2, 2007.

(51) Int. Cl. G08C 19/06

(52) U.S. Cl. 340/870.05

(57) ABSTRACT

The present invention relates to a telemetered characteristic sensor transceiver for exchanging data with at least one remote device. The transceiver includes a housing detachably coupled to a sensor located on a body of a user, the sensor producing a signal indicative of a user characteristic. A processor is formed within the housing and in communication with the sensor for processing the signal produced by the sensor. A transmitter is coupled to the processor for transmitting data to at least one remote device while a receiver is coupled to the processor for receiving data from the at least one remote device. A memory is coupled to the processor for storing data, wherein the processor performs calculations using at least one of the signal produced by the sensor, the data received from the at least one remote device and the data stored in the memory, and performs at least one of storing the calculations in the memory and transmitting the calculations to the at least one remote device through the transmitter.

### CROSS-REFERENCE TO RELATED APPLICATION

This application claims the benefit of earlier filing date and right of priority to U.S. Provisional Application Ser. No. 60/976,886 filed Oct. 2, 2007, the contents of which are hereby incorporated by reference.

### FIELD

The present invention relates to telemetered subcutaneous sensor devices and, more particularly, to devices for wireless communication between an implantable subcutaneous sensor set at a selected insertion site within the body of a user and at least one of a plurality of remotely located therapy-related devices.

### BACKGROUND

Diabetes mellitus is the most common of endocrine disorders, and is characterized by inadequate insulin action. Diabetes mellitus has two principal variants, known as Type 1 diabetes and Type 2 diabetes. The latter is also referred to as DM/II (diabetes mellitus type 2), adult-onset diabetes, maturity-onset diabetes, or NIDDM (non-insulin dependent diabetes mellitus).

Over the years, body characteristics have been determined by obtaining a sample of bodily fluid. For example, diabetics often test for blood glucose levels. Traditional blood glucose determinations have utilized a finger prick method using a lancet to withdraw a small blood sample. These systems are designed to provide data at discrete points but do not provide continuous data to show variations in the characteristic between testing times. These discrete measurements are capable of informing a patient the state of his blood glucose values at a point in time. Thus, the patient has enough information to administer “correction” amounts of insulin to reduce his current blood glucose reading at one point in time. However, these discrete readings are not able to provide enough information for any type of automatic or semi-automatic system of administering insulin based on blood glucose values. Moreover, discrete blood glucose readings only give a limited understanding of one's blood glucose values over time, and thus may not give a patient a complete picture of how his/her blood glucose values vary between discrete measurements.

Recently, a variety of implantable electrochemical sensors have been developed for detecting and/or quantifying specific agents or compositions in a patient's blood or interstitial fluid. For instance, glucose sensors are being developed for use in obtaining an indication of blood glucose levels in a diabetic patient. These glucose sensors connected (wired or wirelessly) to a blood glucose monitor can provide continuous glucose readings over a period of time, such as 3 to 5 days. Such readings are useful in monitoring and/or adjusting a treatment regimen which typically includes the regular administration of insulin to the patient.

Thus, continuous blood glucose readings improve medical therapies with medication infusion pumps of the external type, as generally described in U.S. Pat. Nos. 4,562,751; 4,678,408; and 4,685,903; or implantable medication infusion pumps, as generally described in U.S. Pat. No. 4,573,994, which are herein incorporated by reference. Typical thin film sensors used in these continuous blood glucose monitors are described in commonly assigned U.S. Pat. Nos. 5,390,671; 5,391,250; 5,482,473; and 5,586,553 which are incorporated by reference herein. See also U.S. Pat. No. 5,299,571. In addition, characteristic glucose monitors used to provide continuous glucose data are described in commonly assigned U.S. patent application Ser. No. 11/322,568 entitled “Telemetered Characteristic Monitor System and Method of Using the Same” filed on Dec. 30, 2005, which is herein incorporated by reference in its entirety. In addition, infusion pumps receiving sensor data are described in commonly assigned U.S. patent application Ser. No. 10/867,529 entitled “System for Providing Blood Glucose Measurements to an Infusion Device” filed on Oct. 14, 2004, which is herein incorporated by reference in its entirety.

However, drawbacks associated with a prior glucose sensor system are that a sensor transmitter is only capable of one-way communication and has limited processing power. Hence, the sensor transmitter can only transmit raw sensor data and not calculate sensor blood glucose values itself. Accordingly, in the prior glucose sensor system, it is necessary to couple the sensor transmitter to a specially programmed remote data receiving device, such as a characteristic monitor, to determine actual glucose sensor readings. Therefore, what is needed is a sensor transceiver for use with a blood glucose sensor that is capable of transmitting and receiving therapy-related data and independently calculating sensor blood glucose values.

### SUMMARY

The present invention relates to a telemetered characteristic sensor transceiver for exchanging data with at least one remote device. The transceiver comprising a housing detachably coupled to a sensor located on a body of a user, the sensor producing a signal indicative of a user characteristic, a processor formed within the housing and in communication with the sensor for processing the signal produced by the sensor, a transmitter coupled to the processor for transmitting data to at least one remote device, a receiver coupled to the processor for receiving data from the at least one remote device, and a memory coupled to the processor for storing data. Preferably, the processor performs calculations using at least one of the signal produced by the sensor, the data received from the at least one remote device and the data stored in the memory, and performs at least one of storing the calculations in the memory and transmitting the calculations to the at least one remote device through the transmitter.

In accordance with an embodiment of the present invention, the transceiver exchanges data with a plurality of remote devices in a network structure. In one aspect, the transceiver exchanges data with the at least one remote device in a synchronous manner.

In accordance with another embodiment, the transceiver wakes up from a sleep mode prior to exchanging data with the at least one remote device, wherein the at least one remote device wakes up the transceiver. As such, the transceiver further comprises an ultrasonic sensor for receiving an ultrasonic signal from the at least one remote device when the at least one remote device transmits the ultrasonic signal to the transceiver to wake up the transceiver. Alternatively, the transceiver periodically wakes up independent of the at least one remote device.

In another aspect of the invention, the transceiver exchanges data with the at least one remote device in an asynchronous manner. Preferably, the data exchanged in the asynchronous manner comprises at least one of a blood glucose value and a request for glucose history data.

In accordance with an embodiment of the present invention, the data exchanged between the transceiver and the at least one remote device comprises at least one of device configuration data, communication link configuration data, adaptive communication configuration data, glucose history data, and calibration data. Preferably, the device configuration data comprises at least one of a device identification, user information, and time information. Preferably, the communication link configuration data comprises at least one of a communication rate, frequency information, and frequency hopping configuration information. Preferably, the glucose history data is exchanged according to a time interval. Preferably, the calibration data comprises at least one of sensor initialization sequence and configuration information, and dynamic sensor initialization parameters.

In accordance with another embodiment of the present invention, the processor calculates sensor glucose values using at least one of the signal received from the sensor, the data received from the at least one remote device and the data stored in the memory. Preferably, a rate of exchanging data between the transceiver and the at least one remote device is dynamically changed depending on a characteristic of the calculated sensor glucose values. Preferably, a glucose calculation algorithm for calculating the sensor glucose values is stored in the memory. Preferably, the processor stores the calculated sensor glucose values in the memory or transmits the calculated sensor glucose values to the at least one remote device through the transmitter. Preferably, the calculated sensor glucose values are secured via an encryption scheme before transmission to the at least one remote device.

In accordance with another embodiment of the present invention, the receiver receives calibration data from the at least one remote device and the processor stores the received calibration data in the memory. Preferably, the processor performs a calibration using at least one of the calibration data stored in the memory, the signal received from the sensor and the calculated glucose sensor values. Preferably, a calibration algorithm for performing the calibration is stored in the memory.

In one aspect of the invention, transceiver comprises a display for displaying information processed by the processor. In another aspect, the transceiver comprises means for notifying the user that the at least one remote device is beyond a certain distance from the transceiver.

In a further aspect of the invention, a power for exchanging data between the transceiver and the at least one remote device is dynamically changed depending on a strength of a detected signal between the transceiver and the at least one remote device.

In another aspect of the invention, a rate of exchanging data between the transceiver and the at least one remote device is dynamically changed depending on a power mode of at least one of the transceiver and the at least one remote device.

In accordance with the present invention, the housing is capable of detaching from the sensor and attaching to the at least one remote device. Preferably, the processor communicates with the sensor via wireless means.

In yet a further aspect of the invention, the housing comprises a single communication port for facilitating at least two of communication between the transceiver and the sensor, communication between the transceiver and the at least one remote device, and an electrical connection between the transceiver and a battery charger.

Other features and advantages of the invention will become apparent from the following detailed description, taken in conjunction with the accompanying drawings which illustrate, by way of example, various features of embodiments of the invention.

### BRIEF DESCRIPTION OF THE DRAWINGS

A detailed description of embodiments of the invention will be made with reference to the accompanying drawings, wherein like numerals designate corresponding parts in the several figures.

FIG. 1 is a perspective view illustrating a subcutaneous sensor insertion set and telemetered characteristic sensor transceiver device embodying the novel features of the invention.

FIG. 2 is a longitudinal vertical section of the subcutaneous sensor insertion set and telemetered characteristic sensor transceiver of FIG. 1.

FIG. 3 is an enlarged longitudinal sectional of a slotted insertion needle used in the insertion set of FIGS. 1 and 2.

FIG. 4 is an enlarged transverse section taken generally on the line 4-4 of FIG. 3.

FIG. 5 is an enlarged transverse section taken generally on the line 5-5 of FIG. 3.

FIG. 6 is an enlarged fragmented sectional view of a needle inserted into a body in accordance with one embodiment of the present invention.

FIG. 7 is an enlarged transverse section of a needle inserted into a body in accordance with one embodiment of the present invention.

FIG. 8A is a top plan and partial cut-away view of the telemetered characteristic sensor transceiver in accordance with the embodiment shown in FIG. 1.

FIG. 8B is a simplified block diagram of a printed circuit board of the telemetered characteristic sensor transceiver in accordance with the embodiments shown in FIG. 1.

FIGS. 8C and 8D are top and bottom plan and partial cut-away views of the telemetered characteristic sensor transmitter device in accordance with the embodiment shown in FIG. 1.

FIG. 9 is a simplified block diagram of a telemetered characteristic sensor transceiver and sensor set system in accordance with another embodiment of the present invention.

FIG. 10 is a simplified block diagram of a telemetered characteristic sensor transceiver and characteristic monitor system in accordance with still another embodiment of the present invention.

FIG. 11 is a block diagram of a telemetered characteristic sensor transceiver communicating with a variety of remote electronic devices in a network structure in accordance with another embodiment of the present invention.

FIG. 12 illustrates a telemetered characteristic sensor transceiver capable of connecting to various devices in accordance with one embodiment of the present invention.

FIG. 13 illustrates a communication port of a telemetered characteristic sensor transceiver capable of connecting to various devices in accordance with one embodiment of the present invention.

### DETAILED DESCRIPTION

As shown in the drawings for purposes of illustration, the invention is embodied in a telemetered characteristic sensor transceiver coupled to a sensor set, that may be implanted in and/or through subcutaneous, dermal, sub-dermal, inter-peritoneal or peritoneal tissue, that not only transmits data from the sensor set to a remote therapy-related device, such as a characteristic monitor for determining body characteristics, but may also receive data from the remote device. Although the telemetered characteristic sensor transceiver of the present invention is described below with regard to a characteristic monitor in particular, the transceiver need not operate with such a device alone. The present invention contemplates the transceiver operating with other remote electronic devices, such as infusion pumps, monitors, personal computers and hospital system devices, for example. Moreover, the transceiver may be linked to a single electronic device or numerous devices in a network structure.

In preferred embodiments of the present invention, the sensor set and monitor are for determining glucose levels in the blood and/or body fluids of the user without the use of, or necessity of, a wire or cable connection between the transceiver and the monitor. However, it will be recognized that further embodiments of the invention may use a wired connection or be used to determine the levels of other agents, characteristics or compositions, such as hormones, cholesterol, medication concentrations, pH, oxygen saturation, viral loads (e.g., HIV), or the like.

In other embodiments, the sensor set may also include the capability to be programmed or calibrated using data received and stored by the telemetered characteristic sensor transceiver, or may be calibrated at the monitor (or receiver). The telemetered characteristic sensor system is primarily adapted for use in subcutaneous human tissue. However, still further embodiments may be placed in other types of tissue, such as muscle, lymph, organ tissue, veins, arteries or the like, and used in animal tissue. Embodiments may provide sensor values to and/or receive therapy-related information from a remote device on an intermittent or continuous basis.

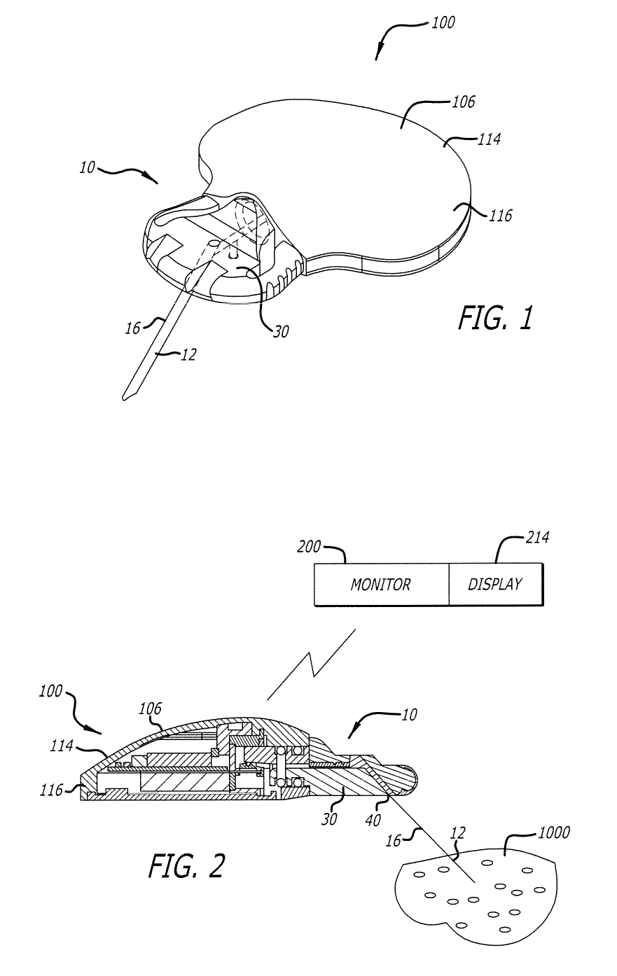

FIG. 1 is a perspective view illustrating a subcutaneous sensor insertion set and telemetered characteristic sensor transceiver device embodying the novel features of the invention. FIG. 2 is an enlarged longitudinal vertical section of FIG. 1. Referring to FIGS. 1 and 2, a telemetered characteristic sensor system, in accordance with a preferred embodiment of the present invention includes a percutaneous sensor set 10, a telemetered characteristic sensor transceiver device 100 and a characteristic monitor 200. Description of the telemetered characteristic sensor is further found in commonly owned co-pending application Ser. No. 11/322,568 entitled “Telemetered Characteristic Monitor System and Method of Using the Same” filed on Dec. 30, 2005, which is incorporated by reference in its entirety. Preferably, the telemetered characteristic sensor system provides for better treatment and glycemic control in an outpatient or home-use environment. For example, the sensor system can provide indications of glucose levels, hypoglycemia/hyperglycemia alerts and outpatient diagnostics. It is also useful as an evaluation tool under a physician's supervision or use in a hospital environment to monitor a patient's health status.

The percutaneous sensor set 10 utilizes an electrode-type sensor, as described in more detail below. However, in alternative embodiments, the system may use other types of sensors, such as chemical based, optical based or the like. In further alternative embodiments, the sensors may be of a type that is used on the external surface of the skin or placed below the skin layer of the user. Preferred embodiments of a surface mounted sensor would utilize interstitial fluid harvested from underneath the skin.

The telemetered characteristic sensor transceiver 100 generally includes the capability to transmit and receive data. For example, in a preferred embodiment, the sensor transmitter 100 will receive a calibration value (e.g. from a blood glucose meter, etc.), convert raw sensor signals into calibrated processed glucose values using algorithms stored in the sensor transceiver 100 and then transmit the calibrated glucose values to a third device which has a display to show the calibrated glucose values (e.g. a characteristic monitor 200). The description of the telemetered characteristic sensor transceiver 100 will be covered in depth below.

In alternative embodiments, the characteristic monitor 200 may be replaced with a data receiver, storage and/or transmitting device for later processing of the transmitted data or programming of the telemetered characteristic sensor transceiver 100. In other embodiments, the characteristic monitor 200 is a bed-side monitor for monitoring body characteristics of a patient. In further embodiments, the telemetered characteristic sensor transceiver 100 can maintain multiple two-way communication links with other devices, such as infusion pumps, monitors, personal computers and hospital system devices, for example.

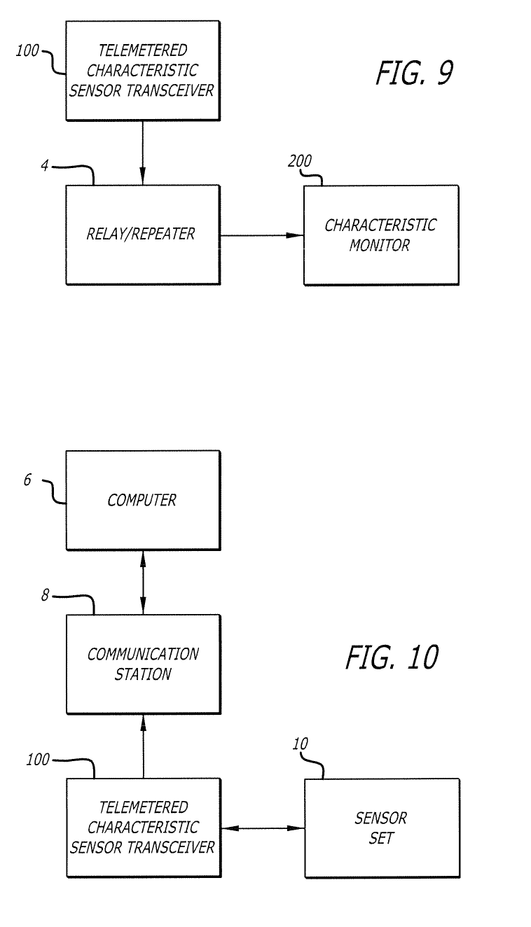

In addition, referring to FIG. 9, a relay or repeater 4 may be used with the telemetered characteristic sensor transceiver 100 and the characteristic monitor 200 to increase the distance that the telemetered characteristic sensor transceiver 100 can be used with the characteristic monitor 200. For example, the relay 4 could be used to provide information to parents of children using the telemetered characteristic sensor transceiver 100 and the sensor set 10 from a distance. The information could be used when children are in another room during sleep or doing activities in a location remote from the parents. In further embodiments, the relay 4 can include the capability to sound an alarm. In addition, the relay 4 may be capable of providing telemetered characteristic sensor transceiver 100 data from the sensor set 10, as well as other data, to a remotely located individual via a modem connected to the relay 4 for display on a monitor, pager or the like. The relay 4 may also be used to transfer information from a remote device to the transceiver 100.

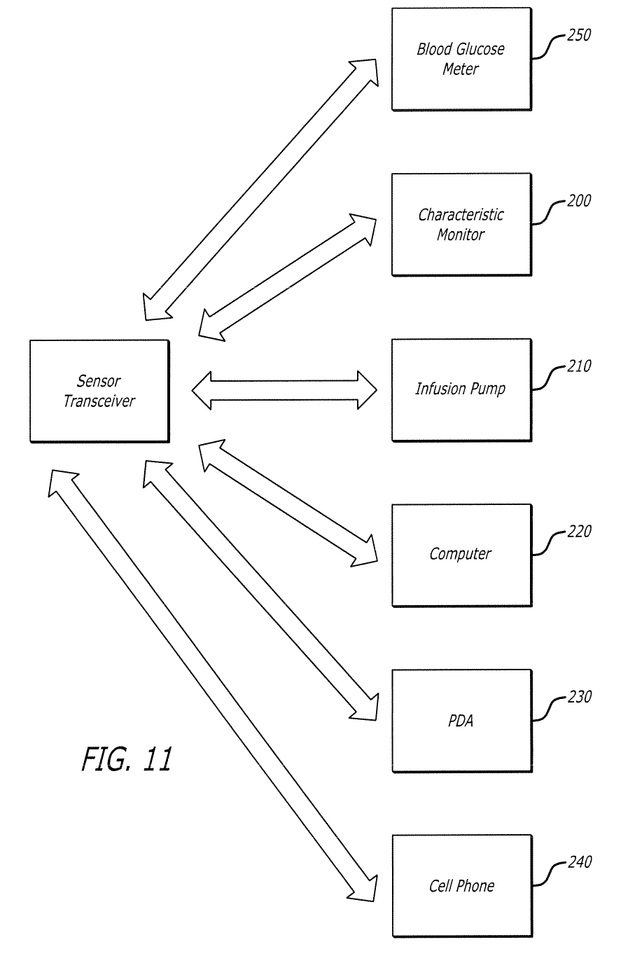

Referring to FIG. 10, data may be exchanged between the transceiver 100 and a remotely located computer 6 such as a personal computer (PC), personal digital assistant (PDA), or the like, through a communication station 8 over communication lines (e.g., modem or wireless connection). In some embodiments, the communication station 8 may be omitted such that the transceiver 100 directly connects to the computer 6 via the modem or wireless connection. In further embodiments, the telemetered characteristic sensor transceiver 100 connects to an RF programmer, which acts as a relay, or shuttle, for data communication between the sensor set 10 and a PC, PDA, communication station, data processor, or the like. In further alternatives, the telemetered characteristic sensor transceiver 100 may transmit an alarm to a remotely located device, such as a communication station, modem or the like to summon help. In addition, further embodiments may include the capability for simultaneous monitoring of multiple sensors and/or include a sensor for multiple measurements.

In one embodiment, the telemetered characteristic sensor transceiver 100 may have and use an input port for direct (e.g., wired) connection for multiple purposes. Possible examples include the ability to directly connect to a programming or data readout device and/or be used for calibration of the sensor set 10. Preferably, the input port is water proof (or water resistant) or includes a water proof, or water resistant, removable cover.

Preferably, the telemetered characteristic sensor transceiver 100 takes characteristic information, such as glucose data or the like, from the percutaneous sensor set 10 and transmits it via wireless telemetry to the characteristic monitor 200, which displays and logs the received glucose readings. Logged data can be downloaded from the characteristic monitor 200 to a PC, PDA, or the like, for detailed data analysis. Alternatively, in accordance with the present invention, glucose values may be calculated and logged by the transceiver 100. Accordingly, the logged data may be downloaded directly from the transceiver 100 by the PC, PDA, insulin pump or the like.

In further embodiments, the telemetered characteristic sensor system may be used in a hospital environment or the like. Still further embodiments of the present invention may include one or more buttons (on the telemetered characteristic sensor transceiver 100 or characteristic monitor 200) to record data and events for later analysis, correlation, or the like. In addition, the telemetered characteristic sensor transceiver 100 may include a transmit/receive on/off button for compliance with safety standards and regulations to temporarily suspend transmissions or receptions. Further buttons can include a sensor on/off button to conserve power and to assist in initializing the sensor set 10. The telemetered characteristic sensor transceiver 100 and characteristic monitor 200 may also be combined with other medical devices to combine other patient data through a common data network and telemetry system.

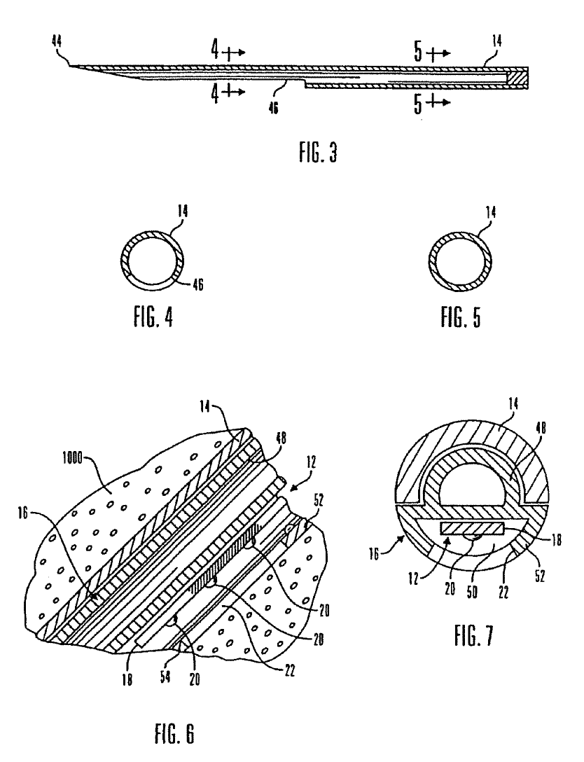

Referring to FIGS. 1-7, a percutaneous sensor set 10 is provided for subcutaneous placement of an active portion of a flexible sensor 12 (see FIGS. 6 and 7), or the like, at a selected site in the body 1000 of a user. The subcutaneous or percutaneous portion of the sensor set 10 includes a hollow, slotted insertion needle 14, and a cannula 16. The needle 14 is used to facilitate quick and easy subcutaneous placement of the cannula 16 at the subcutaneous insertion site. Inside the cannula 16 is a sensing portion 18 of the sensor 12 to expose one or more sensor electrodes 20 to the user's bodily fluids through a window 22 formed in the cannula 16. After insertion, the insertion needle 14 is withdrawn to leave the cannula 16 with the sensing portion 18 and the sensor electrodes 20 in place at the selected insertion site.

In preferred embodiments, the percutaneous sensor set 10 facilitates accurate placement of a flexible thin film electrochemical sensor 12 of the type used for monitoring specific blood parameters representative of a user's condition. Preferably, the sensor 12 monitors glucose levels in the body, and may be used in conjunction with automated or semi-automated medication infusion pumps of the external or implantable type as described in U.S. Pat. No. 4,562,751; 4,678,408; 4,685,903 or 4,573,994, to control delivery of insulin to a diabetic patient.

Preferred embodiments of the flexible electrochemical sensor 12 are constructed in accordance with thin film mask techniques to include elongated thin film conductors embedded or encased between layers of a selected insulative material such as polyimide film or sheet, and membranes. The sensor electrodes 20 at a tip end of the sensing portion 18 are exposed through one of the insulative layers for direct contact with patient blood or other body fluids, when the sensing portion 18 (or active portion) of the sensor 12 is subcutaneously placed at an insertion site. In alternative embodiments, other types of implantable sensors, such as chemical based, optical based, or the like, may be used.

Further description of flexible thin film sensors of this general type are be found in U.S. Pat. No. 5,391,250, entitled METHOD OF FABRICATING THIN FILM SENSORS, which is herein incorporated by reference. A connection portion may be conveniently connected electrically to the monitor 200 or a telemetered characteristic sensor transceiver 100 by a connector block (or the like) as shown and described in U.S. Pat. No. 5,482,473, entitled FLEX CIRCUIT CONNECTOR, which is also herein incorporated by reference. Thus, in accordance with embodiments of the present invention, subcutaneous sensor sets 10 are configured or formed to work with either a wired or a wireless characteristic sensor system.

In accordance with the present invention, the proximal part of the sensor 12 is mounted in a mounting base 30 adapted for placement onto the skin of a user. The mounting base 30 may be a pad having an underside surface coated with a suitable pressure sensitive adhesive layer, with a peel-off paper strip normally provided to cover and protect the adhesive layer, until the sensor set 10 is ready for use. In preferred embodiments, the adhesive layer includes an anti-bacterial agent to reduce the chance of infection; however, alternative embodiments may omit the agent. In the illustrated embodiment, the mounting base is generally oval, but alternative embodiments may be other shapes, such as rectangular, circular, hour-glass, butterfly, irregular, or the like.

An upper portion of the insertion needle 14 is adapted for slide-fit reception through a lower bore 40 formed at an underside of the mounting base 30. As shown, the insertion needle 14 has a sharpened tip 44 and an open slot 46 which extends longitudinally from the tip 44 at the underside of the needle 14 to a position at least within the bore 40. Above the mounting base 30, the insertion needle 14 may have a full round cross-sectional shape, and may be closed off at a rear end of the needle 14. Further description of the needle 14 and the sensor set 10 are found in U.S. Pat. No. 5,586,553, entitled “TRANSCUTANEOUS SENSOR INSERTION SET” and U.S. patent application Ser. No. 08/871,831, entitled “DISPOSABLE SENSOR INSERTION ASSEMBLY,” which are herein incorporated by reference.

The cannula 16 is best shown in FIGS. 6 and 7, and includes a first portion 48 having a partly-circular cross-section to fit within the insertion needle 14 that extends downwardly from the mounting base 30. In alternative embodiments, the first portion 48 may be formed with a solid core, rather than a hollow core. In preferred embodiments, the cannula 16 is constructed from a suitable medical grade plastic or elastomer, such as polytetrafluoroethylene, silicone, or the like. The cannula 16 also defines an open lumen 50 in a second portion 52 for receiving, protecting and guideably supporting the sensing portion 18 of the sensor 12. The cannula 16 has one end fitted into the bore 40 formed at the underside of the mounting base 30, and the cannula 16 may be secured to the mounting base 30 by a suitable adhesive, ultrasonic welding, snap fit or other selected attachment method. From the mounting base 30, the cannula 16 extends angularly downwardly with the first portion 48 nested within the insertion needle 14, and terminates before the needle tip 44. At least one window 22 is formed in the lumen 50 near the implanted end 54, in general alignment with the sensor electrodes 20, to permit direct electrode exposure to the user's bodily fluid when the sensor 12 is subcutaneously placed. Alternatively, a membrane can cover this area with a porosity that controls rapid diffusion of glucose through the membrane.

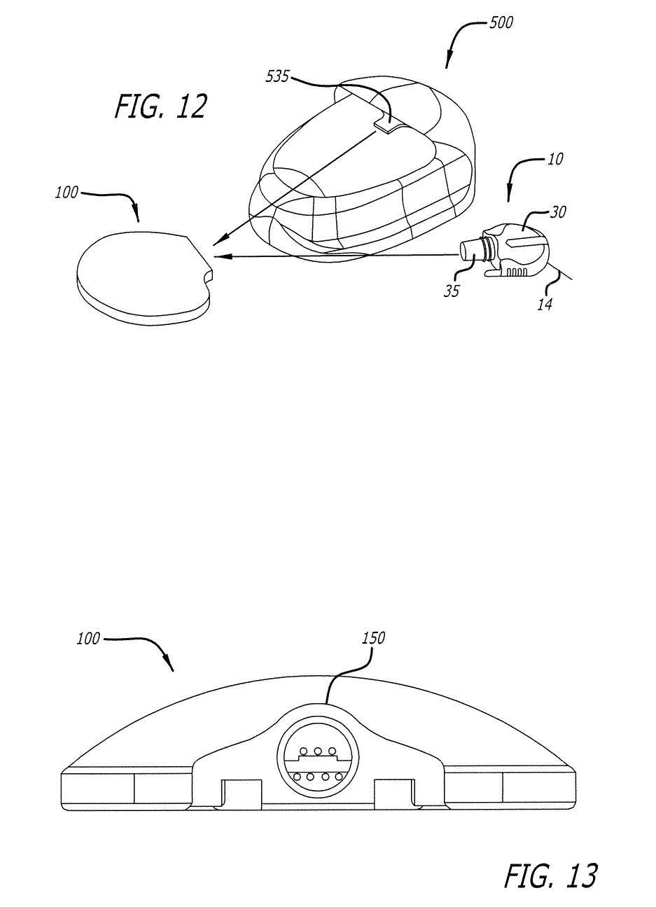

As shown in FIGS. 1, 2 and 8A, the telemetered characteristic sensor transceiver 100 is directly coupled to a sensor set 10 via the mounting base 30. This minimizes the amount of skin surface covered or contacted by medical devices, and minimizes movement of the sensor set 10 relative to the telemetered characteristic sensor transceiver 100. In a preferred embodiment, the transceiver 100 is detachably coupled to the mounting base 30 housing the sensor set 10. Accordingly, the transceiver 100 is coupled to the sensor set after the sensor set has been placed into body 100 of the user. In addition, the transceiver 100 may be detached from the sensor set 10 while the sensor set 10 is implanted in the body 1000 of the user, thus allowing the transceiver 100 to independently attach to other complementary devices if desired. According to the preferred embodiments of the present invention, the characteristic monitor transmitter 100 is coupled to a sensor set 10 using a male/female connection scheme for direct connection to the sensor set 10. In preferred embodiments, as best seen in FIG. 12, the characteristic monitor transmitter 100 shall have a female connector interface 150 (or communication port 150) built into the housing 106 of the characteristic monitor transmitter 100. Detents at the female connector interface 150 are used to mate and lock with locking prongs located on the male sensor connector 35 of the sensor set 10. Alternatively, other detachable connector systems may be used including the modification of the connection scheme to place a female connector on the sensor 10 and the male connector on characteristic monitor transmitter 100.

In accordance with an alternative embodiment, communication between the transceiver 100 and the sensor 12 is performed by wireless means. In one embodiment, the telemetered characteristic sensor transceiver 100 is optically coupled with an implanted sensor, in the subcutaneous, dermal, sub-dermal, inter-peritoneal or peritoneal tissue, to interrogate the implanted sensor using visible, and/or IR frequencies, either transmitting to and receiving a signal from the implanted sensor or receiving a signal from the implanted sensor.

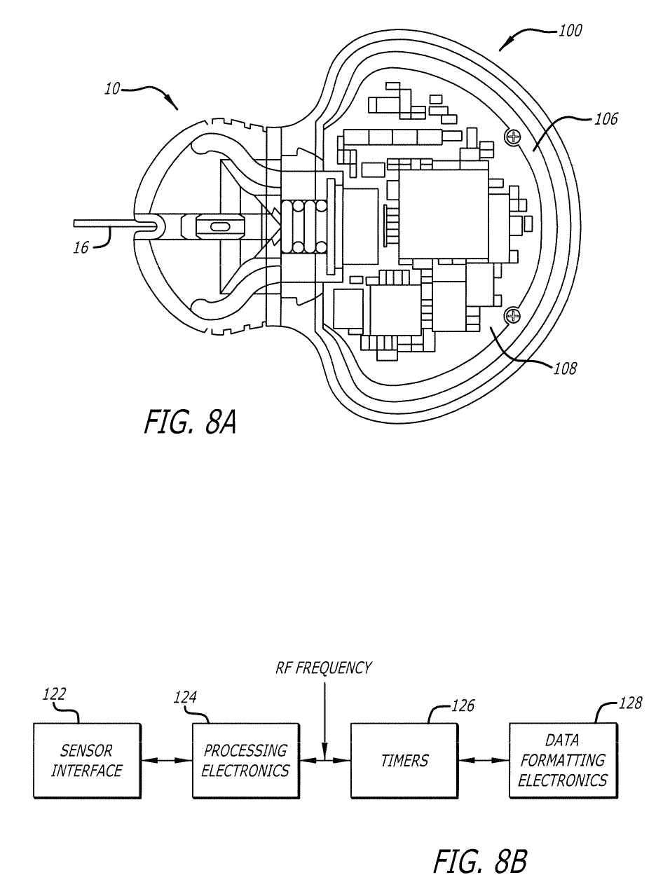

FIGS. 8C and 8D show top and bottom layout diagrams of the characteristic monitor transceiver 100 according to the preferred embodiments. The telemetered characteristic sensor transceiver 100 includes a housing 106 that supports a printed circuit board 108 that contains a voltage regulator 1108, comparators 1110 and 1116, power switch 1112, analog switch 1114, Op Amps 1118, Microprocessor 1120, Digital to Analog Converter 1122, Real Time Clock 1126, EEPROM 1124, RF Transceiver 1128, and a battery 1130, as well as other associated electronics such as an antenna. In preferred embodiments, the housing 106 is formed from an upper case 114 and a lower case 116 that are sealed with an ultrasonic weld to form a waterproof (or resistant) seal to permit cleaning by immersion (or swabbing) with water, cleaners, alcohol or the like. In preferred embodiments, the upper and lower case 114 and 116 are formed from a medical grade plastic. However, in alternative embodiments, the upper case 114 and lower case 116 may be connected together by other methods, such as snap fits, sealing rings, RTV (silicone sealant) and bonded together, or the like, or formed from other materials, such as metal, composites, ceramics, or the like. In other embodiments, the separate case can be eliminated and the assembly is simply potted in epoxy or other moldable materials that is compatible with the electronics and reasonably moisture resistant. In preferred embodiments, the housing 106 is disk or oval shaped. However, in alternative embodiments, other shapes, such as hour glass, rectangular or the like, may be used. Preferred embodiments of the housing 106 are sized in the range of 1.0 square inches and 0.25 inches thick or less to minimize weight, discomfort and the noticeability of the telemetered characteristic sensor transceiver 100 on the body of the user. However, larger or smaller sizes, may be used. Also, the housing may simply be formed from potted epoxy, or other material, especially if the battery life relative to the device cost is long enough, or if the device is rechargeable.

In preferred embodiments, the size of the transceiver 100 has been reduced to fit directly onto the sensor set 10 and be supported by the sensor set 10 itself. Unlike the other embodiments of the present invention that required the transceiver 100 to be attached separately to the body of a user by a separate adhesive tape, the transceiver 100 can remain fixed in its location by being attached to the sensor set 10. In other words, a single adhesive tape used to attach the sensor set to the patient can also support the transceiver 100. In alternative embodiments, the lower case 116 may have an underside surface coated with a suitable pressure sensitive adhesive layer, with a peel-off paper strip normally provided to cover and protect the adhesive layer, until the sensor set telemetered characteristic sensor transceiver 100 is ready for use. In further alternative embodiments, the adhesive layer includes an anti-bacterial agent to reduce the chance of infection. In still further alternative embodiments, the adhesive layer may be omitted and the telemetered characteristic sensor transceiver 100 is secured to the body by other methods, such as an adhesive overdressing, straps, belts, clips or the like.

Referring to FIG. 8B, the printed circuit board 108 of the telemetered characteristic sensor transceiver 100 functionally includes (using the electronics described above) a sensor interface 122, processing electronics 124, timers 126, and data formatting electronics 128. In preferred embodiments, the sensor interface 122, processing electronics 124, timers 126, and data formatting electronics 128 are formed on a single customized semiconductor chip, but in alternative embodiments, separate semiconductor chips can be used. The sensor interface 122 is electrically connected with the sensor set 10 via the mounting base 30 when the transceiver 100 is plugged into the mounting base 30. In preferred embodiments, the sensor interface 122 may be permanently connected to sensor set 10. However, in alternative embodiments, the sensor interface 122 may be configured in the form of a jack to accept different types of cables that provide adaptability of the telemetered characteristic sensor transceiver 100 to work with different types of sensors and/or sensors placed in different locations of the user's body. Still further, in alternative embodiments, communication between the sensor interface 122 and the sensor set 10 may be performed by wireless means. In preferred embodiments, the printed circuit board 108, and associated electronics are capable of operating in a temperature range of 0-50 degrees C. However, larger or smaller temperature ranges may be used.

Preferably, the battery assembly utilizes a weld tab design to connect power to the system. For example, it can use series silver oxide 357 battery cells, or the like. However, it is understood that different battery chemistries may be used, such as lithium based chemistries, alkaline batteries, nickel metalhydride, or the like, and different numbers of batteries can be used. In further embodiments, the sensor interface 122 will include circuitry and/or a mechanism for detecting connection to the sensor set 10. This would provide the capability to save power and to more quickly and efficiently start initialization of the sensor set 10. In preferred embodiments, the batteries have a life in the range of 3 months to 2 years, and provide a low battery warning alarm. Alternative embodiments may provide longer or shorter battery lifetimes, or include a power port, solar cells or an inductive coil to permit recharging of rechargeable batteries in the telemetered characteristic sensor transceiver 100.

According to the alternative preferred embodiments of the present invention, a rechargeable battery is used with the characteristic monitor transceiver 100. Although the concept of a rechargeable battery in a characteristic monitor transmitter has been proposed in the past, the use of a rechargeable battery is contrary to conventional wisdom. Typically, rechargeable batteries are big and heavy and need heavy current to recharge the battery. However, the characteristic monitor transceiver 100 have low current circuits that would not work well with conventional rechargeable batteries. In preferred embodiments, the rechargeable battery is a lithium polymer battery that avoids the problems with conventional rechargeable batteries. The lithium polymer battery has the preferred characteristics of being light, thin, having a high energy density and a shallow current discharge, and good for multiple recharges. In alternative embodiments, different battery chemistry may be used that have the same preferred characteristics of the lithium polymer battery.

In preferred embodiments, the telemetered characteristic sensor transceiver 100 may provide power, through a cable to the sensor set 10. The power is used to monitor and drive the sensor set 10. The power connection is also used to speed the initialization of the sensor 12, when it is first placed under the skin. The use of an initialization process can reduce the time for sensor stabilization from several hours to an hour or less. The preferred initialization procedure uses a two step process. First, a high voltage (preferably between 1.0-1.2 volts—although other voltages may be used) is applied to the sensor 12 for 1 to 2 minutes (although different time periods may be used) to allow the sensor 12 to stabilize. Then, a lower voltage (preferably between 0.5-0.6 volts—although other voltages may be used) is applied for the remainder of the initialization process (typically 58 minutes or less). Other stabilization/initialization procedures using differing currents, currents and voltages, different numbers of steps, or the like, may be used. Other embodiments may omit the initialization/stabilization process, if not required by the sensor or if timing is not a factor.

At the completion of the stabilizing process, a reading may be transmitted from the sensor set 10 and the telemetered characteristic sensor transceiver 100 to the characteristic monitor 200, and then the user will input a calibrating glucose reading into the characteristic monitor 200. In alternative embodiments, a fluid containing a known value of glucose may be injected into the site around the sensor set 10, and then the reading is sent to the characteristic monitor 200 and the user inputs the known concentration value, presses a button (not shown) or otherwise instructs the monitor to calibrate using the known value. In further embodiments, the calibrating glucose reading and/or the known concentration value are transmitted to, and stored in, the sensor transceiver 100. Accordingly, the transceiver 100 can perform the calibration using the received calibrating glucose reading and/or the known concentration value.

During the calibration process, the telemetered characteristic sensor transceiver 100 checks to determine if the sensor set 10 is still connected. If the sensor set 10 is no longer connected, the telemetered characteristic sensor transceiver 100 will abort the stabilization process and sound an alarm (or send a signal to the characteristic monitor 200 to sound an alarm).

As shown in FIG. 2, the characteristic monitor may include a display 214 that is used to display the results of the measurement received from the sensor 12 in the sensor set 10 via the telemetered characteristic monitor transceiver 100. The results and information displayed includes, but is not limited to, trending information of the characteristic (e.g., rate of change of glucose), graphs of historical data, average characteristic levels (e.g., glucose), or the like. Alternative embodiments include the ability to scroll through the data. The display 214 may also be used with buttons (not shown) on the characteristic monitor to program or update data in the characteristic monitor 200. It is noted that the typical user can be expected to have somewhat diminished visual and tactile abilities due to complications from diabetes or other conditions. Thus, the display 214 and buttons should be configured and adapted to the needs of a user with diminished visual and tactile abilities. In alternative embodiments, the value can be conveyed to the user by audio signals, such as beeps, speech or the like. Still further embodiments may use a touch screen instead of (or in some cases addition to) buttons to facilitate water proofing and to ease changes in the characteristic monitor 200 hardware to accommodate improvements or upgrades.

Preferably, the characteristic monitor uses batteries (not shown) to provide power to the characteristic monitor. For example, a plurality of silver oxide batteries may be used. However, it is understood that different battery chemistries may be used, such as lithium based, alkaline based, nickel metalhydride, or the like, and different numbers of batteries can be used. In preferred embodiments, the batteries have a life in the range of 1 month to 2 years, and provide a low battery warning alarm. Alternative embodiments may provide longer or shorter battery lifetimes, or include a power port, solar cells or an induction coil to permit recharging of rechargeable batteries in the characteristic monitor 200. In preferred embodiments, the batteries are not replaceable to facilitate waterproofing of the housing 106.

In further embodiments of the present invention, the characteristic monitor 200 may be replaced by a different device. For example, in one embodiment, the telemetered characteristic sensor transceiver 100 communicates with an RF programmer (not shown) that is also used to program and obtain data from an infusion pump or the like. The RF programmer may also be used to update and program the transceiver 100 since the transceiver 100 preferably includes a receiver for remote programming, calibration or data receipt. The RF programmer can be used to store data obtained from the sensor 18 and then provide the data to either an infusion pump, characteristic monitor, computer or the like for analysis.

In further embodiments, the transceiver 100 may transmit the data to a medication delivery device, such as an infusion pump or the like, as part of a closed loop system. This would allow the medication delivery device to compare sensor results with medication delivery data and either sound alarms when appropriate or suggest corrections to the medication delivery regimen. In preferred embodiments, the transceiver 100 includes a receiver for receiving data from the medication delivery device such that the transceiver 100 can compare sensor results with medication delivery. The transceiver 100 may also use the receiver to receive updates or requests for additional sensor data. An example of one type of RF programmer can be found in U.S. patent application Ser. No. 60/096,994 filed Aug. 18, 1998 entitled “INFUSION DEVICE WITH REMOTE PROGRAMMING, CARBOHYDRATE CALCULATOR AND/OR VIBRATION ALARM CAPABILITIES,” or U.S. Pat. No. 6,554,798 issued on Apr. 29, 2003 entitled “EXTERNAL INFUSION DEVICE WITH REMOTE PROGRAMMING, BOLUS ESTIMATOR AND/OR VIBRATION ALARM CAPABILITIES,” both of which are herein incorporated by reference.

In further embodiments, the telemetered characteristic sensor transceiver may include a modem, or the like, to transfer data to and receive data from a healthcare professional. Preferably, the transceiver can receive updated programming or instructions via a modem connection.

In use, the sensor set 10 permits quick and easy subcutaneous placement of the active sensing portion 18 at a selected site within the body of the user. More specifically, the peel-off strip covering the adhesive layer is removed from the mounting base 30, at which time the mounting base 30 can be pressed onto and seated upon the patient's skin. During this step, the insertion needle 14 pierces the user's skin and carries the protective cannula 16 with the sensing portion 18 to the appropriate subcutaneous placement site. During insertion, the cannula 16 provides a stable support and guide structure to carry the flexible sensor 12 to the desired placement site. When the sensor 12 is subcutaneously placed, with the mounting base 30 seated upon the user's skin, the insertion needle 14 can be slidably withdrawn from the user. During this withdrawal step, the insertion needle 14 slides over the first portion 48 of the protective cannula 16, leaving the sensing portion 18 with electrodes 20 directly exposed to the user's body fluids via the window 22. Further description of the needle 14 and the sensor set 10 are found in U.S. Pat. No. 5,586,553, entitled “TRANSCUTANEOUS SENSOR INSERTION SET”; U.S. Pat. No. 5,954,643, entitled “INSERTION SET FOR A TRANSCUTANEOUS SENSOR”; and U.S. Pat. No. 5,951,521, entitled “A SUBCUTANEOUS IMPLANTABLE SENSOR SET HAVING THE CAPABILITY TO REMOVE OR DELIVER FLUIDS TO AN INSERTION SITE,” which are herein incorporated by reference.

The sensor set 10 is connected to the telemetered characteristic sensor transceiver 100, so that the sensor 12 can be used over a prolonged period of time for taking blood chemistry or other characteristic readings, such as blood glucose readings in a diabetic patient. Preferred embodiments of the telemetered characteristic sensor transceiver 100 detect the connection of the sensor 12 to activate the telemetered characteristic sensor transceiver 100. For instance, connection of the sensor 12 may activate a switch or close a circuit to turn the telemetered characteristic sensor transceiver 100 on. The use of a connection detection provides the capability to maximize the battery and shelf life of the telemetered characteristic sensor transceiver prior to use, such as during manufacturing, test and storage. Alternative embodiments of the present invention may utilize an on/off switch (or button) on the telemetered characteristic monitor transceiver 100.

Once the transceiver 100 is attached to the sensor set 10, the user then activates the transceiver 100, or the transceiver is activated by detection of the connection to the sensor 12 of the sensor set 10. Generally, the act of connecting (and disconnecting) the sensor 12 activates (and deactivates) the telemetered characteristic sensor transceiver 100, and no other interface is required. In alternative steps, the sensor set 10 is connected to the transceiver 100 prior to placement of the sensor 12 to avoid possible movement or dislodging of the sensor 12 during attachment of the transceiver 100. Also, the transceiver may be attached to the user prior to attaching the sensor set 10 to the transceiver 100.

The user then programs the characteristic monitor (or it learns) the identification of the transceiver 100 and verifies proper operation and calibration of the transceiver 100. The characteristic monitor 200 and transceiver 100 then work to transmit and receive sensor data to determine characteristic levels. Thus, once a user attaches a transceiver 100 to a sensor set 10, the sensor 12 is automatically initialized and readings are periodically transmitted, together with other information, to the characteristic monitor 200. Additionally, the transceiver 100 is ready to receive data from the characteristic monitor 200 or other remote electronic device.

As stated above, the telemetered characteristic sensor transceiver 100 of the present invention is capable of two-way communication. Thus, the transceiver 100 overcomes the limitations of the prior art sensor system capable of only one-way communication. The telemetered characteristic monitor transceiver 100 can transmit data to, as well as receive data or requests from, a characteristic monitor or other electronic device. Hence, in accordance with the present invention, the characteristic monitor or electronic device the telemetered characteristic sensor transceiver 100 communicates with also comprises a transceiver for transmitting and receiving data.

Accordingly, because the telemetered characteristic sensor transceiver of the present invention is capable of two-way communication, the transceiver 100 may be linked to various devices that can receive sensor glucose values, such as infusion pumps, monitors, personal computers and hospital system devices, in a stand alone or network structure. Preferably, by running proprietary calibration, filtering and calibration algorithms on the sensor transceiver 100, sensor glucose values can be transmitted to a variety of non-proprietary devices. Thus, the process of monitoring glucose levels is more convenient for the user. FIG. 11 is a block diagram of a telemetered characteristic sensor transceiver communicating with a variety of remote electronic devices in a network structure. As shown, the transceiver 100 can maintain multiple two-way communication links with the characteristic monitor 200, an infusion pump 210, a computer 220, a PDA 230, a cellular phone 240 and a blood glucose meter 250. All of these devices may then take further action based on the current glucose information such as giving alarms, alerts, changing protocols, notifying third parties, etc. In further embodiments, the transceiver 100 can even send signals to an automobile which can display the sensor reading on display in the car (e.g. GPS/stereo interface). In even further embodiments, the car may advice the driver to pull over if the driver is driving or don't start the car if the driver is just entered the car, if the blood sugar levels are at dangerous levels.

In one preferred embodiment, it is not necessary for the transceiver 100 to be in a reciprocal communication link with an electronic device to communicate information to the electronic device. For example, the transceiver 100 may arbitrarily broadcast data signals to a surrounding area up to a specific range. Accordingly, any of a number of electronic devices within the specific range, such as the characteristic monitor 200, the infusion pump 210, the computer 220, the PDA 230, the cellular phone 240 and the blood glucose meter 250, for example, which are capable of receiving a signal from the transceiver 100 may automatically/optionally receive the broadcasted information. Thus, the transceiver 100 need not be reciprocally connected to the device, by wireless or wired means, in order to communicate information to the device.

In accordance with one embodiment of the present invention, because actual sensor glucose values are being transmitted from the transceiver 100 to any of a number of remote devices, security measures are needed to ensure privacy. For example, in one aspect of the invention, the sensor glucose values are encrypted or appended with a security key prior to transmission to prevent unwanted devices from reading the information. Preferably, remote devices, which are intended to receive the sensor glucose values, are provided with the ability to decrypt the transmitted data or unlock the appended security key in order to read the data.

In accordance with one embodiment of the present invention, the telemetered characteristic sensor transceiver 100 may periodically exchange data with other network nodes (i.e., a pump, monitor, computer, cellular phone, etc.) in a synchronous manner. For example, a new electronic device may enter into the network of the transceiver 100 by first waking up the transceiver 100 from a sleep mode. Thereafter, the new electronic device synchronizes communication with the transceiver to establish a communication link. Alternatively, the transceiver 100 may periodically wake up for the purpose of detecting a new device, and subsequently synchronize communication with any new devices detected.

In one aspect of the invention, the transceiver may wake up from a sleep mode according to a magnetic swipe procedure. In another aspect of the invention, the transceiver 100 comprises an ultrasonic sensor such that a remote electronic device can wake the transceiver 100 by transmitting an ultrasonic signal to the transceiver 100. Notably, use of the ultrasonic signal wake-up scheme is advantageous because power is conserved.

In accordance with another embodiment of the present invention, the telemetered characteristic sensor transceiver 100 may irregularly or aperiodically exchange data with other network nodes in an asynchronous manner. For example, a glucose meter may aperiodically transmit blood glucose (BG) values to the transceiver 100, wherein the meter blood glucose values are preferably stored and used by the transceiver 100 to calibrate calculated sensor glucose values. In another example, a computer may request a download of glucose history data from the transceiver 100.

During two-way communication between the transceiver 100 and other network nodes, various types of information may be exchanged either synchronously or asynchronously. For example, information related to device configuration may be exchanged. This may include a device identifier, patient information and time information. Communication link information may also be exchanged, which may include a communication rate, a frequency (e.g., 916 Mhz or 868 Mhz) and configuration options for frequency hopping. Adaptive communication configuration information, which will be described below, may also be exchanged. Furthermore, history data and calibration information can be exchanged. This may include calibration data, sensor initialization sequence and configuration information, dynamic sensor initialization parameters and glucose history data.

In one aspect of the present invention, the dynamic sensor initialization parameters may require the application of an initialization sequence when a calibration factor falls below a certain value. Furthermore, the glucose history data may be transmitted based on a time interval. For example, data points acquired between a first arbitrary point in time and a second arbitrary point in time may be transmitted from the transceiver 100 to a network node.

In accordance with another embodiment of the present invention, the telemetered characteristic sensor transceiver 100 is capable of performing data calibration and sensor glucose value calculation unlike pre-existing glucose sensor transmitters. Because the transceiver 100 is capable of two-way communication and substantial processing power, the transceiver 100 can receive and store calibration data from a remote network device, such as meter blood glucose values, and use this data to calibrate the sensor's readings. Accordingly, the transceiver 100 can appropriately calculate sensor glucose values using the calibrated sensor readings, and store the values for a period of time based on a rate at which the sensor glucose values are calculated. Thus, the user does not need to wait to obtain values from a meter or other remote device before performing calibration because the calibration data would already be stored in the transceiver 100. In previous systems, it was necessary to couple a transmitter to a monitor, or remote device, to extract actual sensor glucose readings. However, in the present invention, sensor glucose values can be calculated using just one device.

In accordance with the present invention, calculating sensor glucose values at the transceiver 100 has many advantages. For example, more data points are available for sensor calibration and sensor glucose value calculation. Because data acquisition is no longer limited by a transmission rate, the transceiver 100 can periodically read sensor data and run at least one of a calibration algorithm and a glucose value calculation algorithm if needed.

Another advantage is that glucose history information is stored on the transceiver 100. Thus, because the transceiver 100 can be networked to a plurality of devices, the information is available to any receiver or network node on demand. Furthermore, the transceiver 100 can continuously calculate glucose values even when a remote device is not in proximity to the user. Thus, when communication between the transceiver 100 and the remote device fails, the calibration algorithm can continue to calculate glucose data points. Preferably, when communication is re-established, the remote device can synchronize data with the transceiver 100 and receive glucose values calculated while the remote device was not communicating with the transceiver 100.

In one aspect of the invention, the transceiver 100 may comprise a display for displaying information transmitted, received or processed by the transceiver 100. In another aspect of the invention, the transceiver 100 may include a small vibrator or beep alarm to indicate to the user that a remote device is not near by.

In accordance with another embodiment of the present invention, a synchronous communication rate between the transceiver 100 and a remote device is dynamic based on at least one of glucose information (data or trend), glucose threshold information and communication status. For example, a communication rate may be increased when a blood glucose value is beyond a normal range, or represents a steep rise or drop in blood glucose value. The communication rate can also be proportional to a risk factor. In another example, the communication rate may be decreased when blood glucose conditions are normal. In a further example, a communication power may be increased when communication is lost or a low signal strength is detected between the transceiver 100 and the remote device.

In accordance with another embodiment of the present invention, the synchronous communication rate between the transceiver 100 and the remote device can depend on a power mode. For example, if the transceiver 100 is in a power-saving mode, then the rate of communication may be decreased.

In one aspect of the invention, real-time calibration and glucose calculation algorithms are coded on the transceiver 100. Moreover, non-real-time (i.e., retrospective) algorithms may be stored on a remote device.

FIG. 12 illustrates a telemetered characteristic sensor transceiver capable of connecting to various devices in accordance with one embodiment of the present invention. As stated above, the transceiver 100 may be detachably coupled to the mounting base 30, which houses the sensor set 10, thus allowing the transceiver 100 to independently attach to other complementary devices. Referring to FIG. 12, in a preferred embodiment, the transceiver 100 is capable of detaching from the mounting base 30 and separately attaching to a complementary device, such as a battery charger 500. As such, when a user of the transceiver 100 wishes to recharge the transceiver 100, the user can easily do so without having to withdraw the needle 14 from the insertion site before recharging, and reinsert the needle 14 after recharging, because the transceiver 100 can independently attach to the battery charger 500.

FIG. 13 illustrates a communication port of a telemetered characteristic sensor transceiver capable of connecting to various devices in accordance with one embodiment of the present invention. Referring to FIGS. 12 and 13, a single communication port 150 of the transceiver 100 is capable of operating with the sensor set 10, as well as other complementary devices, such as the battery charger 500. As shown, an upper portion of the communication port 150 may receive a male connecting portion 35 of the mounting base 30. Preferably, the male connecting portion 35 is electrically coupled to the sensor set 10. Thus, when the male connecting portion 35 is inserted into the communication port 150, the sensor set 10 and the transceiver 100 can operationally communicate with each other.

Furthermore, a lower portion of the communication port 150 is capable of receiving connecting portions of other electrical devices. For example, the lower portion of the communication port 150 may receive a connecting portion 535 of the battery charger 500. Thus, when the connecting portion 535 is inserted into the communication port 150, the battery charger 500 is operationally coupled with the transceiver 100 to provide the transceiver 100 with power. In other embodiments, the lower portion of the communication port 150 may receive connecting portions of other electrical devices for facilitating communication. Thus, when a connecting portion of an electrical device is inserted into the lower portion of the communication port 150, the electrical device is able to exchange information with the transceiver 100.

While the description above refers to particular embodiments of the present invention, it will be understood that many modifications may be made without departing from the spirit thereof. Thus, the accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A telemetered characteristic sensor transceiver for exchanging data with at least one remote device, the transceiver comprising:
a housing detachably coupled to a sensor located on a body of a user, the sensor producing a signal indicative of a user characteristic;
a processor formed within the housing and in communication with the sensor for processing the signal produced by the sensor;
a transmitter coupled to the processor for transmitting data to at least one remote device;
a receiver coupled to the processor for receiving data from the at least one remote device; and
a memory coupled to the processor for storing data,
wherein the processor performs calculations using at least one of the signal produced by the sensor, the data received from the at least one remote device and the data stored in the memory, and performs at least one of storing the calculations in the memory and transmitting the calculations to the at least one remote device through the transmitter.

2. The transceiver of claim 1, wherein the transceiver exchanges data with a plurality of remote devices in a network structure.

3. The transceiver of claim 1, wherein the transceiver exchanges data with the at least one remote device in a synchronous manner.

4. The transceiver of claim 1, wherein the transceiver wakes up from a sleep mode prior to exchanging data with the at least one remote device.

5. The transceiver of claim 4, wherein the at least one remote device wakes up the transceiver.

6. The transceiver of claim 5, further comprising an ultrasonic sensor for receiving an ultrasonic signal from the at least one remote device when the at least one remote device transmits the ultrasonic signal to the transceiver to wake up the transceiver.

7. The transceiver of claim 4, wherein the transceiver periodically wakes up independent of the at least one remote device.

8. The transceiver of claim 1, wherein the transceiver exchanges data with the at least one remote device in an asynchronous manner.

9. The transceiver of claim 8, wherein the data exchanged in the asynchronous manner comprises at least one of:
a blood glucose value; and
a request for glucose history data.

10. The transceiver of claim 1, wherein the data exchanged between the transceiver and the at least one remote device comprises at least one of:
device configuration data;
communication link configuration data;
adaptive communication configuration data;
glucose history data; and
calibration data.

11. The transceiver of claim 10, wherein the device configuration data comprises at least one of:
a device identification;
user information; and
time information.

12. The transceiver of claim 10, wherein the communication link configuration data comprises at least one of:
a communication rate;
frequency information; and
frequency hopping configuration information.

13. The transceiver of claim 10, wherein the glucose history data is exchanged according to a time interval.

14. The transceiver of claim 10, wherein the calibration data comprises at least one of:
sensor initialization sequence and configuration information; and
dynamic sensor initialization parameters.

15. The transceiver of claim 1, wherein the processor calculates sensor glucose values using at least one of the signal received from the sensor, the data received from the at least one remote device and the data stored in the memory.

16. The transceiver of claim 15, wherein a rate of exchanging data between the transceiver and the at least one remote device is dynamically changed depending on a characteristic of the calculated sensor glucose values.

17. The transceiver of claim 15, wherein a glucose calculation algorithm for calculating the sensor glucose values is stored in the memory.

18. The transceiver of claim 15, wherein the processor stores the calculated sensor glucose values in the memory or transmits the calculated sensor glucose values to the at least one remote device through the transmitter.

19. The transceiver of claim 18, wherein the calculated sensor glucose values are secured via an encryption scheme before transmission to the at least one remote device.

20. The transceiver of claim 15, wherein the receiver receives calibration data from the at least one remote device and the processor stores the received calibration data in the memory.

21. The transceiver of claim 20, wherein the processor performs a calibration using at least one of the calibration data stored in the memory, the signal received from the sensor and the calculated glucose sensor values.

22. The transceiver of claim 21, wherein a calibration algorithm for performing the calibration is stored in the memory.

23. The transceiver of claim 1, further comprising a display for displaying information processed by the processor.

24. The transceiver of claim 1, further comprising means for notifying the user that the at least one remote device is beyond a certain distance from the transceiver.

25. The transceiver of claim 1, wherein a power for exchanging data between the transceiver and the at least one remote device is dynamically changed depending on a strength of a detected signal between the transceiver and the at least one remote device.

26. The transceiver of claim 1, wherein a rate of exchanging data between the transceiver and the at least one remote device is dynamically changed depending on a power mode of at least one of the transceiver and the at least one remote device.

27. The transceiver of claim 1, wherein the housing is capable of detaching from the sensor and attaching to the at least one remote device.

28. The transceiver of claim 1, wherein the processor communicates with the sensor via wireless means.

29. The transceiver of claim 1, wherein the housing comprises a single communication port for facilitating at least two of:
communication between the transceiver and the sensor;
communication between the transceiver and the at least one remote device; and
an electrical connection between the transceiver and a battery charger.
